(19) United States
(12) Patent Application Publication
(10) Pub. No.: US 2025/0162177 A1
(43) Pub. Date: May 22, 2025

(54) GRIPPING CONTROL METHOD OF ROBOT HAND

(71) Applicant: NISSHA CO.,LTD., Kyoto (JP)

(72) Inventor: Yuji WATAZU, Kyoto (JP)

(73) Assignee: NISSHA CO.,LTD., Kyoto (JP)

(21) Appl. No.: 18/836,496

(22) PCT Filed: Dec. 26, 2022
(86) PCT No.: PCT/JP2022/047912

§ 371 Date: Aug. 7, 2024

(30) Foreign Application Priority Data
Feb. 17, 2022 (JP) 2022-023235

(51) Int. Cl. B25J 15/08; B25J 9/16; B25J 13/08

(52) U.S. Cl. CPC B25J 15/08; B25J 9/1612; B25J 13/083

(57) ABSTRACT

Technical Problem: To provide a gripping control method of a robot hand, which can easily grip a target object to be gripped stably without using an image recognition process by camera photographing. Solution to Problem: A gripping control method of a robot hand of the present invention includes a gripping step S1, a shear force distribution detection step S2, a moment value calculation step S3, a slip occurrence evaluation step S4, a slip prediction evaluation step S5, a centroid position estimation step S6, a gripping position moving step S7, and a conveyance continuation step S8.

### TECHNICAL FIELD

The present invention relates to a gripping control method of a robot hand, which can stably grip a target object to be gripped.

### BACKGROUND ART

At present, robots are active not only in manufacturing but also in service and health care industries. Many of these robots have robot hands so as to convey various objects or grip tools to work like humans.

In the robot hand, it is necessary to measure various contact states such as a gripping force and a shear force generated in the palm face of the finger gripping the target object to be gripped. For example, detecting the shear force that the robot hand receives from the target object to be gripped allows to determine the minimum gripping force required for the robot hand to grip the target object to be gripped without dropping the target object.

Thus, Patent Document 1 proposes to provide a tactile sensor capable of measuring three component forces on the palm face of the finger of the robot hand.

### CITATION LIST

### Patent Literature

PTL 1: JP 2008-281403 A

### SUMMARY OF INVENTION

### Technical Problem

However, in the case where the shape of the target object to be gripped is unknown in the first place, or in the case of the target object to be gripped difficult to be known at first glance where to grip in order to prevent slipping even when the shape of the target object to be gripped is known, even when the robot hand obtains the output value of the shear force received from the target object to be gripped, how to derive the correct gripping position is not known from the output value. As a result, it is difficult to prevent dropping of the target object to be gripped while conveying the target object to be gripped to the target location.

As a technique to prevent dropping of the target object to be gripped, an image recognition process using camera photographing is used. This is to accurately recognize the shape and position of the target object to be gripped by the camera, move the robot hand to the target object to be gripped with high accuracy, and grip the target object to be gripped. Although this method can certainly increase the probability of success in stopping the drop, there is a problem that the image recognition process takes time every time the robot works, and the robot hand has to move at a low speed, so that gripping of the target object to be gripped takes a long time.

Thus, it is an object of the present invention to provide a gripping control method of a robot hand, which can solve the above problem and easily grip the target object to be gripped stably without using the image recognition process by camera photographing.

### Solution to Problem

A plurality of aspects will be described below as a technique for solving the problem. These aspects may be arbitrarily combined.

The present invention is a gripping control method of a robot hand. Here, the robot hand includes a plurality of fingers. The robot hand also includes a gripper, which supports the rear ends of the fingers and drives the fingers to grip or release the target object to be gripped. The robot hand also includes a tactile sensor, which is provided on the gripping surface of the finger and can measure the distribution of shear forces on the sensing surface. The robot hand is attached to the tip of a robot arm.

A gripping control method of a robot hand according to one viewpoint of the present invention includes a gripping step, a shear force distribution detection step, a moment value calculation step, a slip occurrence evaluation step, a centroid position estimation step, a gripping position moving step, and a conveyance continuation step. In the gripping step, a robot hand grips the placed target object to be gripped. In the shear force distribution detection step, a swirling shear force distribution is detected by a tactile sensor while the robot hand slightly raises the gripper with the target object to be gripped being gripped. In the moment value calculation step, a moment value applied to the robot hand is calculated from the detected shear force distribution. In the slip occurrence evaluation step, it is evaluated whether the target object to be gripped is slipping, from the change of the calculated moment value during the slight raising of the gripper. In the centroid position estimation step, when it is evaluated that the target object to be gripped is slipping, the centroid position of the target object to be gripped is estimated from the direction and magnitude of the moment. In the gripping position moving step, the gripping position of the robot hand is moved to the estimated position of the centroid position. In the conveyance continuation step, the robot hand finally conveys the target object to be gripped to a target location. After moving the gripping position of the robot hand to the estimated centroid position, the flow returns back to the shear force distribution detection step. The gripping control method of a robot hand configured in this way can determine the correct gripping position from the moment received by the robot hand immediately after starting the raising of the target object to be gripped by the robot hand without taking time until gripping the target object to be gripped, thereby gripping stably the target object to be gripped easily.

The gripping control method of the robot hand described above may be configured in such a manner that, in the slip occurrence evaluation step, it is evaluated that the target object to be gripped is slipping when a sudden decrease occurs in the moment value during slight raising of the gripper of the robot hand.

The gripping control method of the robot hand described above may further include a slip prediction evaluation step. In the slip prediction evaluation step, it is evaluated whether the slip of the target object to be gripped is predicted if the robot hand keeps conveying the target object to be gripped, from the change in the moment value during the slight raising, once it is evaluated that the target object to be gripped is not slipping. In this way, also when the slip prediction evaluation step evaluates that the slip of the target object to be gripped is predicted, the centroid position of the target object to be gripped is estimated, and the gripping position of the robot hand is moved to the estimated centroid position.

Since the gripping control method of the robot hand configured in this manner can predict the slip from the change of the moment, the target object to be gripped can be gripped more stably.

In the slip prediction evaluation step, the gripping control method of the robot hand may be configured to evaluate that the slip of the target object to be gripped is predicted by the fact that the ratio of the increase in the value of the moment relative to the slight raising of the robot hand exceeds a threshold value.

The gripping control method of the robot hand described above may be configured such that the robot hand further includes an elastic body covering the sensing surface of the tactile sensor.

The gripping control method of the robot hand configured in this manner can more clearly detect shear force because bulge deformation parallel to the sensing surface occurs in the elastic body.

The gripping control method of the robot hand described above may be further configured to include a lowering step that lowers the gripper of the robot hand to a position before the slight raising, prior to the gripping position moving step.

The gripping control method of the robot hand configured in this manner, has no risk that the orientation of a target object to be gripped W will change when the gripper of the robot hand is released.

### Advantageous Effects of Invention

The gripping control method of the robot hand of the present invention enables the target object to be easily gripped stably without using image recognition process by camera photographing.

### BRIEF DESCRIPTION OF DRAWINGS

FIG. 1 is a diagram illustrating an example of a robot used for a gripping control method of a robot hand.

FIG. 2 is a schematic diagram illustrating an example of a robot hand.

FIG. 3 is a schematic diagram illustrating an example of a finger with a tactile sensor of the robot hand.

FIG. 4 is a schematic diagram illustrating an example of a shear force distribution detected by the tactile sensor.

FIG. 5 is a schematic diagram illustrating another example of a shear force distribution detected by the tactile sensor.

FIG. 6 is a schematic diagram for describing a gripping step and a shear force distribution detection step.

FIG. 7 is a schematic diagram for describing a moment received by the tactile sensor from the target object to be gripped.

FIG. 8 is a graph illustrating an example of an evaluation method regarding slipping.

FIG. 9 is a graph illustrating another example of an evaluation method regarding slipping.

FIG. 10 is a schematic diagram illustrating an example of a method for estimating the centroid position.

FIG. 11 is a flowchart illustrating an example of the gripping control method of the robot hand.

FIG. 12 is a flowchart illustrating another example of the gripping control method of the robot hand.

FIG. 13 is a flowchart illustrating another example of the gripping control method of the robot hand.

FIG. 14 is a graph illustrating an example of detecting a slip start due to an accident during a conveyance continuation step.

### DESCRIPTION OF EMBODIMENTS

### First Embodiment

Hereinafter, a gripping control method of a robot hand according to a first embodiment of the present invention will be described with reference to the drawings.

### (1) OUTLINE OF ROBOT

### (1-1) Robot

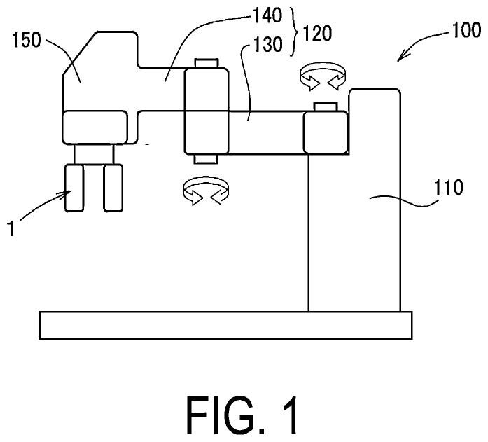

FIG. 1 illustrates an example of a robot used for a gripping control method of a robot hand. A robot 100 illustrated in FIG. 1 is a horizontal articulated robot (SCARA robot), which includes a base 110 and a robot arm 120 rotatably connected to the base 110. Additionally, the robot arm 120 includes a first arm 130 rotatably connected to the base 110 around a vertical axis via a joint mechanism, a second arm 140 rotatably connected to the first arm 130 around a vertical axis via a joint mechanism, and an operation head 150 provided at the tip of the second arm 140. A robot hand 1 is attached to the lower end of the operation head 150. The operation head 150 can rotate the robot hand 1 around a vertical axis and is vertically movable.

### (1-2) Robot Hand

The robot hand 1 will be described in more detail below.

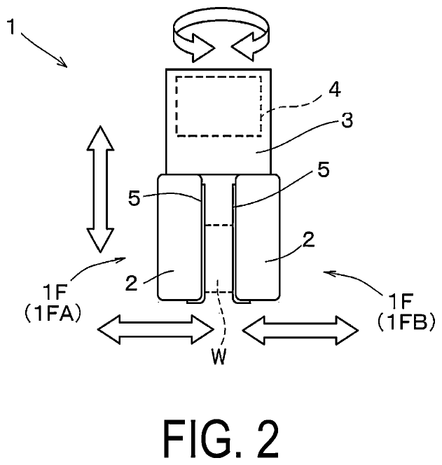

FIG. 2 is a schematic diagram illustrating an example of a robot hand.

In the example illustrated in FIG. 2, the robot hand 1 includes two fingers 1F (1FA, 1FB) each with a tactile sensor. Each finger 1F with a tactile sensor includes a finger 2 and a tactile sensor 5 stuck to the outer surface of a housing 21 constituting the finger 2. The robot hand 1 also includes a gripper 3 for supporting the respective rear ends of the two fingers 2 and a drive portion 4 for driving the fingers 2. The drive portion 4 can move the two fingers 2 in a direction approaching and leaving each other. This enables the robot hand 1 to grip the target object to be gripped W or release the target object to be gripped W being gripped. The robot hand 1 as a whole can also move vertically and rotate as necessary.

The target object to be gripped W is not particularly limited, and includes various industrial products, agricultural crops, products of various sizes and shapes, and products whose exact shape is unknown.

### (1-2-1) Finger

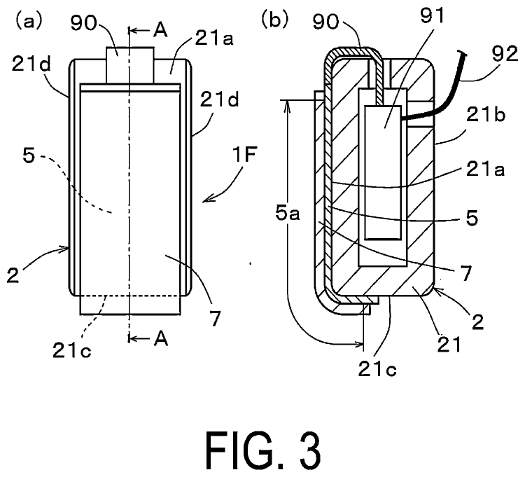

FIG. 3 is a schematic diagram illustrating an example of a finger with a tactile sensor of a robot hand. FIG. 3(a) is a diagram of a finger with a tactile sensor viewed from the palm face side of the finger. FIG. 3(b) is a cross section of the AA line illustrated in FIG. 3(a).

Each finger 2 is composed of the housing 21 that is a roughly rectangular parallelepiped, which includes: a palm face 21a in contact with (gripping the target object to be gripped W by the robot hand) the target object to be gripped W; a back face 21b opposite to the palm face 21a; a tip end face 21c adjacent to the palm face 21a and the back face 21b at the tip in an extending direction X of the palm face 21a and the back face 21b; and both side faces 21d, 21d adjacent to the palm face 21a and the back face 21b in a direction Y intersecting the extending direction X of the palm face 21a and the back face 21b. The housing 21 is composed of resin or metal.

Each finger 2 is non-articulated in the example as illustrated in FIGS. 2 and 3. Thus, the fingers 1F each with a tactile sensor grip the target object to be gripped W by the approach of the palm faces 21a parallel to each other.

### (1-2-2) Tactile Sensor

As illustrated in FIG. 3, the tactile sensor 5 is a film-shaped object stuck to the outer surface of the housing 21 constituting the finger 2. The tactile sensor 5 includes a region (a pressure-sensitive area 5a) detectable by an electrode (not illustrated) in the structure. In an example illustrated in FIG. 3, the pressure-sensitive area 5a overlaps the palm face 21a and the tip end face 21c of the finger 2.

The tactile sensor 5 is a 3-axis force sensor that detects a force to push (pressure) and a force to slide (friction force) in the pressure-sensitive area 5a. Implementing the tactile sensor 5 in the fingers 2 of the robot hand 1 allows to measure not only the force gripping the target object to be gripped W, but also the magnitude of actions such as “twisting”, “pushing”, and “pulling”. As such the tactile sensor 5, for example, a known capacitive pressure sensitive sensor can be used.

In the tactile sensor 5, a wiring pattern connected to an electrode is formed in the non-pressure-sensitive area existing outside the pressure-sensitive area 5a. As illustrated in FIG. 3(b), for example, the wiring pattern is taken out from the tactile sensor 5 by a film connector 90 and electrically connected to a PCB (printed circuit board) 91 stored inside the housing 21 constituting the finger 2 of the robot hand 1. The signal processed by a PCB 91 is sent from the PCB 91 to the robot arm 120 side via a cable 92.

### (1-2-3) Adhesive Layer

The tactile sensor 5 is stuck to the finger 2 of the robot hand 1 by an adhesive layer (not illustrated). The adhesive layer may be composed of, for example, a double-sided tape.

### (1-2-4) Protecting Layer

The sensing surface of the tactile sensor 5 is covered with a protecting layer 7 as illustrated in FIG. 3.

The protecting layer 7 protects at least the pressure-sensitive area of the tactile sensor 5 to which force is applied. The upper surface of the protecting layer 7 is in contact with the target object to be gripped W.

The materials of the protecting layer 7 include rubber sheets made of urethane, silicone, epoxy, ethylene vinyl acetate copolymer, polyethylene, polypropylene, polystyrene, butadiene, or the like, and elastic materials such as foam materials. Coating with the protecting layer 7 is performed by sticking these rubber sheets and foam materials. The housing 21 to which the tactile sensor main body 5 is stuck may be installed in a forming mold, and a liquid rubber material or the like may be poured and molded by insert molding. The thickness of the protecting layer 7 is preferably 0.5 mm to 5 mm.

In addition, various design sheets can be stuck to the surface of the protecting layer 7. Depending on the purpose, design properties can be added by sticking leather or cloth in addition to a picture sheet. In addition, a picture can be formed on the protecting layer 7 itself.

### (2) GRIPPING CONTROL METHOD FOR ROBOT HAND

### (2-1) Outline of Control

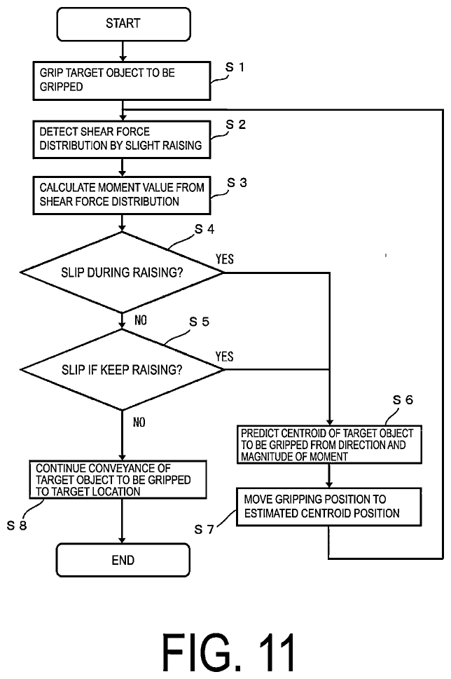

FIG. 11 is a flowchart illustrating an example of a gripping control method of the robot hand 1.

The gripping control method of the robot hand described below includes a gripping step S1, a shear force distribution detection step S2, a moment value calculation step S3, a slip occurrence evaluation step S4, a slip prediction evaluation step S5, a centroid position estimation step S6, a gripping position moving step S7, and a conveyance continuation step S8.

First, in the gripping step S1, the robot hand 1 grips the placed target object to be gripped W.

Next, in the shear force distribution detection step S2, the tactile sensor 5 detects the swirling shear force distribution, during a time period in which the robot hand 1 slightly raises the gripper 3 while gripping the target object to be gripped W.

Next, in the moment value calculation step S3, a value of a moment M applied to the robot hand 1 is calculated from the detected shear force distribution.

The moment in the present specification is a moment of the force applied to the finger 2, and the value of the moment is calculated from the position of an action point to be set and the friction force distribution detected by the tactile sensor 5.

Specifically, the moment is defined as follows.

It is assumed that a two-dimensional stress vector detected at an arbitrary position [symbol] =(x, y) on the pressure-sensitive surface of the tactile sensor is defined as [symbol] (x, y)=(σₓ (x, y), σ_{y}(x,y)), an action point is set on the pressure-sensitive surface of the tactile sensor, and the position coordinates of the action point are defined as [symbol] , then moment M is calculated as follows.

$$M = \int ( \vec{r} - \vec{a} ) \times \vec{σ} ( x , y ) dxdy$$

The integration is performed over the entire pressure-sensitive surface of the tactile sensor 5.

The action point is preferably set in the range with which the target object to be gripped W is in contact within the pressure-sensitive surface. The range of the pressure-sensitive surface with which the target object to be gripped W is in contact may be a range in which the magnitude of the friction force detected by the tactile sensor 5 is no less than a certain value, or a range in which the pressure force is no less than a certain value by enabling the tactile sensor 5 to detect the distribution of the pressure force (stress in the normal direction to the surface). Further, the tactile sensor 5 may detect the distribution of the pressure force (stress in the normal direction to the surface), and the centroid value of the pressure force distribution may be set as the action point.

In the next slip occurrence evaluation step S4, it is evaluated whether the target object to be gripped W is slipping from the change of the calculated moment M value during the slight raising. When it is evaluated that the target object to be gripped W is not slipping (in the drawing, NO), the flow proceeds to the next slip prediction evaluation step S5. However, when it is evaluated that the target object to be gripped W is slipping (in the drawing, YES), the flow proceeds to the centroid position estimation step S6.

Next in the slip prediction evaluation step S5, it is evaluated whether the slip of the target object to be gripped W is predicted if the robot hand 1 keeps conveying the target object to be gripped W, from the change in the calculated moment M value during the slight raising. When it is evaluated that the slip of the target object to be gripped W is not predicted (in the drawing, NO), the flow proceeds next to the conveyance continuation step S8. However, when it is evaluated that the slip of the target object to be gripped W is predicted (in the drawing, YES), the flow proceeds to the centroid position estimation step S6.

In the centroid position estimation step S6, the centroid position g of the target object to be gripped W is estimated from the direction and magnitude of the moment M.

Next, in the gripping position moving step S7, the gripping position of the robot hand 1 is moved to the estimated centroid position g.

After the gripping position of the robot hand 1 is moved, the flow returns to the shear force distribution detection step S2. That is, the gripping position of the robot hand 1 is corrected and repeated until the slip occurrence evaluation step S4 and the slip prediction evaluation step S5 are cleared and the flow advances to the conveyance continuation step S8.

In the last conveyance continuation step S8, the robot hand 1 conveys the target object to be gripped W to the target location.

### (2-2) Gripping Step S1

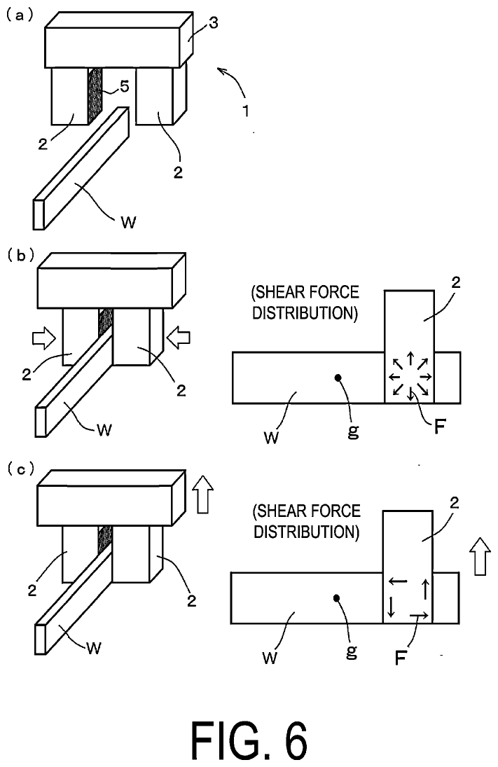

FIGS. 6(a) and 6(b) are schematic diagrams for describing the gripping step S1.

In the example illustrated in FIG. 6(a), the target object to be gripped W is an elongated strip-shaped plate and is mounted on a tray or the like with elongated side faces as the top and bottom. On the other hand, the robot hand 1 includes two fingers 2 in the rectangular parallelepiped shape and the gripper 3 supporting the rear ends of the fingers 2, and the two fingers 2 are separated from each other. The tactile sensors 5 are stuck on the opposing surfaces of the two fingers 2, respectively.

With the robot hand 1 moved from the state of FIG. 6(a) to the position where the target object to be gripped W inserted between the two fingers 2, the robot hand 1 grips the target object to be gripped W by moving the two fingers 2 in a direction approaching each other by the drive of the drive portion 4 (not illustrated), as illustrated in the left diagram of FIG. 6(b). At this time, the target object to be gripped W remains on the tray or the like and is not gripped in the vertical direction, that is, the gravity direction.

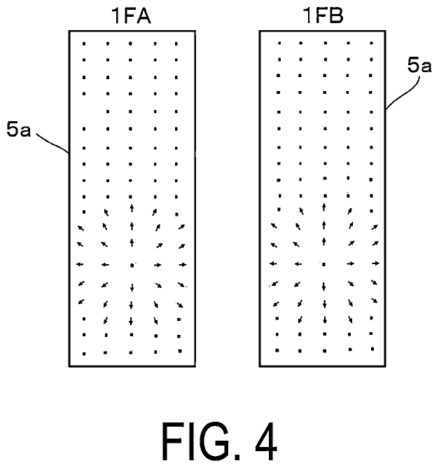

The protecting layer 7 composed of an elastic body is covered on the surface of the tactile sensor 5 as described above and the bulge deformation occurs, so that a shear force F is detected radially around the center of the overlapping area between the tactile sensor 5 and the target object to be gripped W immediately after gripping the target object to be gripped W (see the right diagram of FIG. 6(b)). In FIG. 6(b), the radiating direction is schematically illustrated with only eight arrows indicating the shear force F, but in reality, the distribution of the shear force F on the respective sensing surfaces of the fingers 1FA and 1FB with a tactile sensor is much finer (see FIG. 4).

### (2-3) Shear Force Distribution Detection Step S2

FIG. 6(c) is a schematic diagram for describing the shear force distribution detection step S2.

In the shear force distribution detection step S2, the gripper 3 of the robot hand 1 is raised slightly with the target object to be gripped W being gripped.

In the example illustrated in FIG. 6(c), the gripper 3 is raised slightly by the vertical movement of the whole robot hand 1. That is, the gripper 3 attached to the tip of the robot arm 120 is raised slightly by the movement of the robot arm 120 not illustrated in FIG. 6. Alternatively, the gripper 3 can be raised slightly by providing a mechanism to move the gripper 3 vertically in the robot hand 1.

During this slight raising, the shear force distribution detected by the tactile sensor 5 changes the direction of the shear force F from radial to swirl. In the example illustrated in FIG. 6(c), the direction of the swirling is counterclockwise.

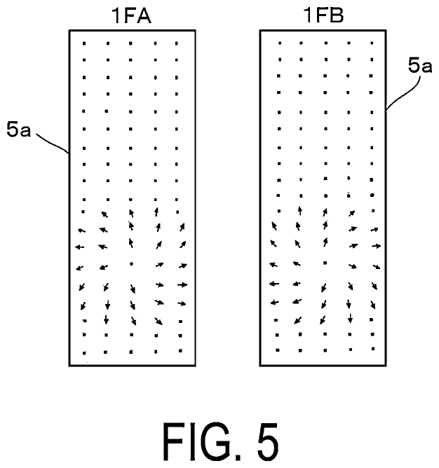

In FIG. 6(c), swirling is schematically illustrated with only four arrows indicating the shear force F, but in reality, the distribution of the shear force F on the respective sensing surfaces of the fingers 1FA and 1FB with a tactile sensor is much finer (see FIG. 5). On the data of shear force F detected by the tactile sensor 5, the radial force distribution immediately after gripping the target object to be gripped W illustrated in FIG. 6(b) is superimposed with the force distribution rotating in a swirling pattern when the target object to be gripped W illustrated in FIG. 6(c) is raised slightly while the target object is gripped. Thus, the swirling shear force distribution can be obtained by subtracting the data immediately after gripping from the data detected during the slight raising.

The degree of the slight raising in the present specification, although varies depending on the material of the target object to be gripped W and the environment in which the target object to be gripped W is placed, is immediately the state after starting to raise the gripper 3 of the robot hand 1 that is gripping the placed target object W. In numerical terms, a time can be used when the magnitude of a force Fy in which the weight of the target object to be gripped W pulls the sensing surface of the tactile sensor 5 downward exceeds a threshold value, once the gripper 3 of the robot hand 1 is raised while the target object W is gripped. This threshold value is, for example, ¼ of the weight of the target object to be gripped W.

### (2-4) Moment Value Calculation Step S3

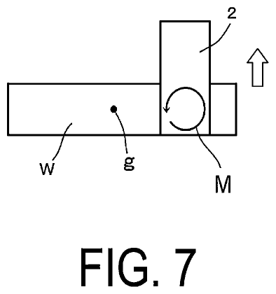

FIG. 7 is a schematic diagram for describing the moment M received from the target object to be gripped W by the tactile sensor 5.

In the moment value calculation step S3, the value of the moment M applied to the robot hand 1 is calculated from the detected shear force distribution. The target object to be gripped W in a strip-shape has a centroid position g at its center. In the example illustrated in FIG. 7, the gripping position of the robot hand 1 is located rightward of the centroid position g of the target object to be gripped W. That is, in the target object to be gripped W, the part on the left side of the gripping position of the robot hand 1 is heavier than the part on the right side. The part on the left side of the target object to be gripped W is likely to go down and the part on the right side is likely to go up, thereby applying the force to rotate the target object to be gripped W. Thus, when the robot hand 1 raises the target object to be gripped W, the moment M acts counterclockwise in the overlapping area between the tactile sensor 5 and the target object to be gripped W.

### (2-5) Slip Occurrence Evaluation Step S4

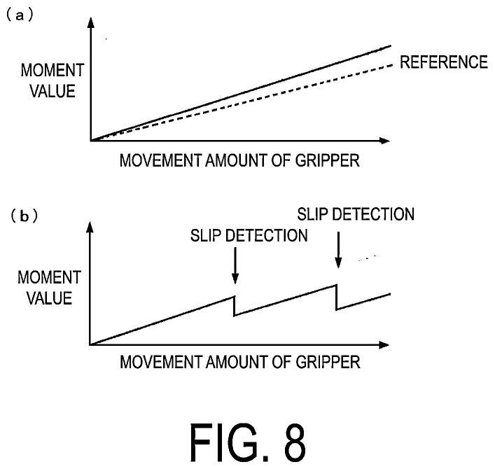

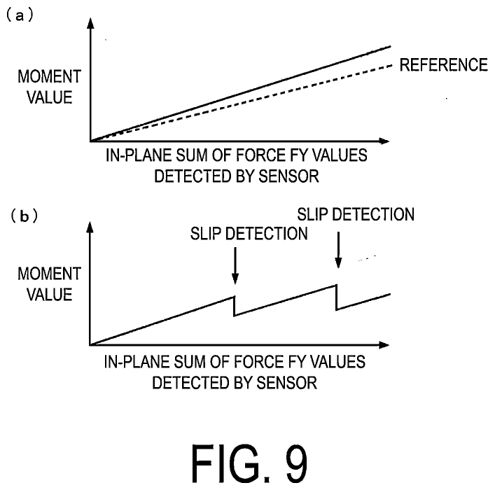

FIG. 8 is a graph illustrating an example of a slip evaluation method. FIG. 9 is a graph illustrating another example of the slip evaluation method.

In the slip occurrence evaluation step S4, it is evaluated whether the target object to be gripped W is slipping from the change of the calculated value of the moment M during the slight raising.

One of the evaluation methods is to monitor the change amount of the moment value relative to the movement amount of the gripper 3 of the robot hand 1. As illustrated in FIG. 8(b), when the moment value suddenly decreases, it is judged that a slip has occurred at that point.

As another evaluation method, when the gripper 3 of the robot hand 1 is raised with the target object to be gripped W being gripped, the change amount of the moment value is monitored relative to the in-plane sum of the force Fy values in which the weight of the target object to be gripped W pulls the sensing surface of the tactile sensor 5 downward. As illustrated in FIG. 9(b), when the moment value suddenly decreases, it is judged that a slip has occurred at that point.

### (2-6) Slip Prediction Evaluation Step S5

In the slip prediction evaluation step S5, it is evaluated whether the slip of the target object to be gripped W is predicted if the robot hand 1 keeps conveying the target object to be gripped W, from the change of the calculated value of the moment M during the slight raising.

One of the evaluation methods is to monitor the change amount of the moment value relative to the movement amount of the gripper 3 of the robot hand 1. When the slope of the change of the moment value illustrated in FIG. 8(a) is greater than a reference (broken line in the drawing), it is judged that the robot hand 1 is gripping a place far from the centroid position g of the target object to be gripped W, and that the slip of the target object to be gripped W is predicted, if the target object to be gripped W is kept to be conveyed.

As another evaluation method, when the gripper 3 of the robot hand 1 is raised with the target object to be gripped W being gripped, the change amount of the moment value is monitored relative to the in-plane sum of the force Fy values in which the weight of the target object to be gripped W pulls the sensing surface of the tactile sensor 5 downward. When the slope of the change of the moment value illustrated in FIG. 9(a) is greater than a reference (broken line in the drawing), it is judged that the robot hand 1 is gripping a part located in a place far from the centroid position g of the target object to be gripped W, and that the slip of the target object to be gripped W is predicted if the target object to be gripped W is kept to be conveyed.

The slope of the reference (broken lines in FIGS. 8(a) and 9(a)) is appropriately determined by the material, shape and weight of the target object to be gripped W and the gripping force of the robot hand 1. In addition, the robot may learn a slope that does not cause the slip from a great number of successful and unsuccessful conveyances in the past by the robot hand 1.

### (2-7) Centroid Position Estimation Step S6

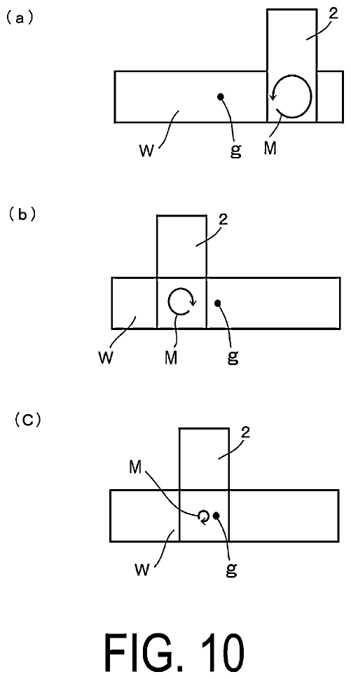

FIG. 10 is a schematic diagram illustrating an example of a method for estimating the centroid position.

In the centroid position estimation step S6, the centroid position g of the target object to be gripped W is estimated from the direction and magnitude of the moment M.

In the example illustrated in FIG. 10(a), the direction of the moment M received by the tactile sensor 5 from the target object to be gripped W is counterclockwise, so that it can be recognized that the rotation occurs such that the target object to be gripped W is oriented downward in the left part. That is, the centroid position g of the target object to be gripped W is on the left side of the gripping position of the robot hand 1.

In the example illustrated in FIG. 10(b), the direction of the moment M received by the tactile sensor 5 from the target object to be gripped W is clockwise, so that it can be recognized that the rotation occurs such that the target object to be gripped W is oriented downward in the right part. That is, the centroid position g of the target object to be gripped W is on the right side of the gripping position of the robot hand 1.

In the example illustrated in FIG. 10(b), the magnitude of the moment M received by the tactile sensor 5 from the target object to be gripped W is less than that illustrated in FIG. 10(a). That is, the gripping position of the robot hand 1 in the example illustrated in FIG. 10(b) is closer to the centroid position g of the target object to be gripped W.

In the example illustrated in FIG. 10(c), the direction of the moment M received by the tactile sensor 5 from the target object to be gripped W is clockwise, so that the centroid position g of the target object to be gripped W is on the right side of the gripping position of the robot hand 1, as in the example illustrated in FIG. 10(b).

In the example illustrated in FIG. 10(c), the magnitude of the moment M received by the tactile sensor 5 from the target object to be gripped W is less than that illustrated in FIG. 10(b). That is, the gripping position of the robot hand 1 in the example illustrated in FIG. 10(c) is further closer to the centroid position g of the target object to be gripped W.

### (2-8) Gripping Position Moving Step S7

In the gripping position moving step S7, the gripping position of the robot hand 1 is moved to the estimated centroid position g. By moving the gripping position of the robot hand 1, the flow returns back to the gripping step S1, and the subsequent steps are repeated until the slip prediction evaluation step S5 evaluates that the slip of the target object to be gripped W is not predicted.

For example, in the example illustrated in FIG. 10(a), since the centroid position g of the target object to be gripped W is on the left side of the gripping position of the robot hand 1, the gripping position of the robot hand 1 is moved to the left side of the current gripping position.

As a result, in case of reaching the example illustrated in FIG. 10(b), the centroid position g of the target object to be gripped W is on the right side of the gripping position of the robot hand 1, so that the gripping position is moved to the right side. Moreover, since the gripping position of the robot hand 1 is closer to the centroid position g of the target object to be gripped W than before the movement, the amount of movement is to be reduced.

Further, as a result, in case of reaching the example illustrated in FIG. 10(c), since the centroid position g of the target object to be gripped W is on the right side of the gripping position of the robot hand 1, the amount of movement is still insufficient. Moreover, since the gripping position of the robot hand 1 is closer to the centroid position g of the target object to be gripped W in the second movement than after the first movement, the amount of movement is to be further reduced this time.

By repeating the above, the gripping position of the robot hand 1 approaches the centroid position g of the target object to be gripped W.

In the gripping position moving step S7, the gripping of the target object to be gripped W is temporarily released before the movement of the gripping position, and the target object to be gripped W is gripped again after the movement of the gripping position is completed. If the gripping is not released, the target object to be gripped W itself moves with the robot hand 1 due to friction between the robot hand 1 and the target object to be gripped W.

### (2-9) Conveyance Continuation Step S8

In the last conveyance continuation step S8, since the gripping position of the robot hand 1, in which the target object to be gripped W is not slippery, has been determined, the robot hand 1 conveys the target object to be gripped W to the target location with the gripping position as it is. In the present step, the robot arm 120 can be raised to a predetermined speed and moved.

In the present specification, the conveyance includes not only moving the target object to be gripped W in the vertical direction and the horizontal direction, but also rotating the target object to be gripped W.

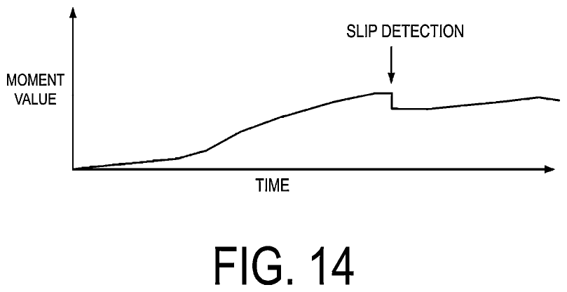

Incidentally, in the conveyance continuation step S8, when a slip occurs by any chance in the target object to be gripped W due to an accident other than the gripping control, for example, the vibration of the ground where the robot 100 is installed or the collision of something in the surroundings, the start of the slip during the conveyance continuation step S8 can be detected by monitoring the amount of change in the moment value over time at that time (see FIG. 14). In this case, since it is difficult to change the gripping position during the conveyance in the air, the gripping force is adjusted to cope with the situation. Alternatively, after placing the target object to be gripped W in a stable place, the gripping step S1 is re-started to cope with the situation.

### (3) MODIFIED EXAMPLE

### (3-1) Modified Example 1

In the first embodiment, the case where the robot 100 is a horizontal articulated robot has been illustrated and described, but the robot 100 is not limited thereto. For example, the robot main body 100 may be another robot such as a vertical articulated robot.

### (3-2) Modified Example 2

In the first embodiment described above, the case where the finger 2 of the robot hand 1 is non-articulated has been illustrated and described, but the finger 2 is not limited thereto. For example, each finger 2 may include 1 to 2 joints.

### (3-3) Modified Example 3

In the first embodiment described above, the case where the finger 2 of the robot hand 1 includes two fingers of two-finger types has been illustrated and described, but the finger 2 is not limited thereto. For example, the finger 2 may be of a multi-finger type such as a three-finger type with three fingers or a five-finger type similar to that of a human. In the case of the robot hand 1 of a multi-finger type, it is preferable to combine with the joints described in modified example 2.

For example, the fingers 2 of a three-finger type or a five-finger type are discretely arranged in the circumferential direction of the vertical axis of the gripper 3 supporting the rear ends of the fingers 2, and these fingers 2 are each moved in the direction approaching and leaving the axis by bending the joints of each finger 2 by the drive portion 4.

### (3-4) Modified Example 4

In the first embodiment described above, the case where the tactile sensor 5 includes the pressure-sensitive area 5a that extends and overlaps only the palm face 21a and the tip end face 21c has been illustrated and described, but the tactile sensor 5 is not limited thereto. The pressure-sensitive area 5a may be present only in the palm face 21a for only a slip countermeasure of the target object to be gripped W. The pressure-sensitive area 5a may extend and overlap with the palm face 21a and at least one of the two side faces 21d, 21d. The pressure-sensitive area 5a may extend and overlap with the palm face 21a, the tip end face 21c, and at least one of the two side faces 21d, 21d.

### (3-5) Modified Example 5

In the first embodiment described above, the finger 2 of the robot hand 1 is composed of the housing 21 that is a roughly rectangular parallelepiped, but is not limited thereto. For example, at least one of the palm face 21a, tip end face 21c, and two side faces 21d, 21d of the finger 2 may be composed of multiple faces and overlap with the pressure-sensitive area 5a.

### Second Embodiment

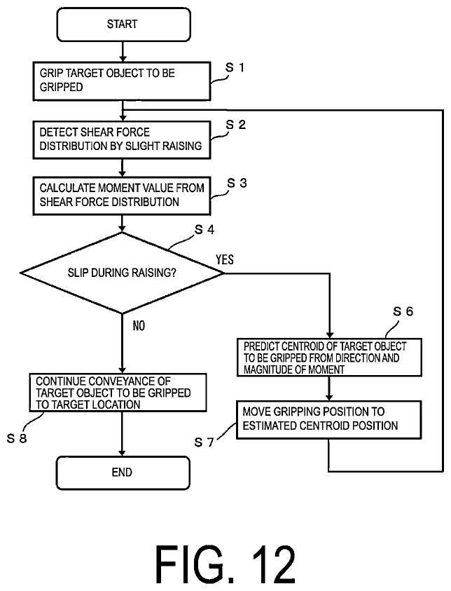

Next, the gripping control method of a robot hand according to the second embodiment of the present invention will be described with reference to FIG. 12.

FIG. 12 is a flowchart illustrating another example of the gripping control method of the robot hand 1.

The gripping control method of a robot hand according to the second embodiment includes the gripping step S1, the shear force distribution detection step S2, the moment value calculation step S3, the slip occurrence evaluation step S4, the centroid position estimation step S6, the gripping position moving step S7, and a conveyance continuation step S8. That is, the second embodiment differs from the first embodiment in that the slip prediction evaluation step S5 is not included.

As illustrated in FIG. 12, when it is evaluated in the slip occurrence evaluation step S4 that the target object to be gripped W is not slipping (in the drawing, NO), the flow directly proceeds to the conveyance continuation step S8.

On the other hand, when it is evaluated in the slip occurrence evaluation step S4 that the target object to be gripped W is slipping (in the drawing, YES), the flow proceeds to the centroid position estimation step S6, the gripping position moving step S7, and then returns to the shear force distribution detection step S2. That is, the gripping position of the robot hand 1 is corrected and repeated until the slip occurrence evaluation step S4 is cleared and the flow advances to the conveyance continuation step S8.

For example, when the target object to be gripped W is not slipping in the shear force distribution detection step S2 for the reason such that the target object to be gripped W is conveyed at a short distance, the second embodiment may be used once the target object to be gripped W continues to be conveyed without causing a major problem.

As for other points, the description overlaps with the first embodiment, so that the description will be omitted. In addition, each modified example described in the first embodiment can also be applied to the second embodiment.

### Third Embodiment

In the first and second embodiments described above, the robot hand 1 includes the protecting layer 7 composed of an elastic body, which covers the sensing surface of the tactile sensor 5, but the protecting layer 7 needs not be included.

As for other points, the description overlaps with the first embodiment, so that the description will be omitted. Each modified example described in the first embodiment can also be applied to the third embodiment.

### Fourth Embodiment

In the first to third embodiments described above, the gripping position moving step S7 is performed with the gripper 3 of the robot hand 1 raised slightly, but the present invention is not limited thereto.

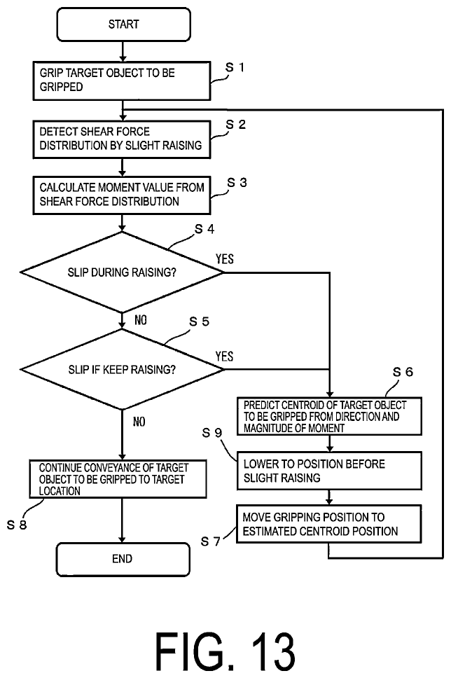

That is, as illustrated in FIG. 13, the fourth embodiment differs from the first embodiment in further including the lowering step S9 that lowers the gripper of the robot hand to the position before the slight raising, prior to the gripping position moving step S7.

In the fourth embodiment, the orientation of the target object to be gripped W does not change when the gripper of the robot hand is released. However, in the range of the slight raising in the present specification, the orientation of the target object to be gripped W is unlikely to change when the gripper is released, and thus, the first embodiment is generally preferable in consideration of the fact that the time to lower the gripper and the number of times of contact with the mounting surface when the gripper is lowered increase (the risk of breakage).

As for other points, the description is the same as the first embodiment, so that the description will be omitted. In addition, each modified example described in the first embodiment can also be applied to the fourth embodiment.

Embodiments of the present invention have been described above, but the present invention is not limited to the above embodiments, and various modifications can be made within the scope not departing from the gist of the invention. In particular, the plurality of embodiments and modified examples described herein can be arbitrarily combined.

### REFERENCE SIGNS LIST

1 Robot hand
1F Finger with tactile sensor
2 Finger
21 Housing
21a Palm face
21b Back face
21c Tip end face
21d Side face
3 Gripper
4 Drive portion
5 Tactile sensor
5a Pressure-sensitive area
7 Protecting layer
90 Film connector
91 PCB
92 Cable
100 Robot
110 Base
120 Robot arm
130 First arm
140 Second arm
150 Operation head
F Shear force
g Centroid position
M Moment
W Target object to be gripped

1. A gripping control method of a robot hand which is mounted on a tip of a robot arm, the robot hand including a plurality of fingers, a gripper configured to support rear ends of the plurality of fingers and drive the plurality of fingers in a manner to grip or release a target object to be gripped, and a tactile sensor provided on a gripping surface of each of the plurality of fingers and configured to measure a shear force distribution on a sensing surface of each of the plurality of fingers, the gripping control method comprising:
gripping, by the robot hand, the placed target object to be gripped;
detecting a shear force distribution in a swirling pattern by the tactile sensor while the robot hand slightly raises the gripper with the target object to be gripped being gripped;
calculating a value of a moment applied to the robot hand from the shear force distribution detected;
evaluating whether the target object to be gripped is slipping, from a change in the value of the moment calculated during slight raising of the gripper;
estimating a centroid position of the target object to be gripped from a direction and a magnitude of the moment when it is evaluated that the target object to be gripped is slipping;
moving a gripping position of the robot hand to the centroid position; and
conveying the target object to be gripped to a target location by the robot hand, wherein
the detecting a shear force distribution is performed again, after the moving a gripping position of the robot hand to the centroid position.

2. The gripping control method of a robot hand, according to claim 1, wherein the evaluating whether the target object to be gripped is slipping includes evaluating that the target object to be gripped is slipping when a sudden decrease occurs in the value of the moment during the slight raising of the gripper of the robot hand.

3. The gripping control method of a robot hand according to claim 1, further comprising:
evaluating whether a slip of the target object to be gripped is predicted if the robot hand keeps conveying the target object to be gripped, from a change in the value of the moment during the slight raising, once it is evaluated that the target object to be gripped is not slipping, wherein
even when it is evaluated that the slip of the target object to be gripped is predicted, the centroid position of the target object to be gripped is estimated, and the gripping position of the robot hand is moved to the centroid position.

4. The gripping control method of a robot hand according to claim 3, wherein it is evaluated that the slip of the target object to be gripped is predicted when a ratio of an increase in the value of the moment relative to the slight raising of the robot hand exceeds a threshold value.

5. The gripping control method of a robot hand according to claim 1, wherein the robot hand further includes an elastic body covering the sensing surface of the tactile sensor.

6. The gripping control method of a robot hand according to claim 1, further comprising:
lowering the gripper of the robot hand to a position before the slight raising, prior to the moving a gripping position.

7. The gripping control method of a robot hand according to claim 1, further comprising that,
when the grasped object slips,
monitoring an amount of change in the moment value with respect to the passage of time at that time and detecting the start of slipping during conveying the target object to be gripped to the target location by the robot hand.

8. The gripping control method of a robot hand according to claim 1, wherein a finger of the plurality of fingers includes a joint.

9. The gripping control method of a robot hand according to claim 1, wherein the plurality of fingers includes at least two fingers.

10. The gripping control method of a robot hand according to claim 1, wherein the robot hand includes a palm surface having a pressure sensing area.

11. A gripping control method of a robot hand which is mounted on a tip of a robot arm, the gripping control method comprising:
gripping a target object by the robot hand having a tactile sensor;
raising a gripper of the robot hand with the target object;
detecting a shear force distribution in a swirling pattern by the tactile sensor while the robot hand raises the gripper of the robot hand with the target object;
calculating a value of a moment applied to the robot hand from the shear force distribution;
evaluating whether the target object is slipping from a change in the value of the moment calculated during the raising of the gripper;
determining whether the target object is slipping based on the evaluation;
if the target object is slipping, estimating a centroid position of the target object within the gripper from a direction and a magnitude of the moment; and
moving a gripping position of the robot hand to the centroid position of the target object.

12. The gripping control method of claim 11, further comprising conveying the target object to a target location by the robot hand.

13. The gripping control method of claim 11, further comprising detecting the shear force distribution after moving the gripping position of the robot hand to the centroid position.

14. The gripping control method of claim 13, further comprising, if the target object is not slipping, conveying the target object to a target location by the robot hand.

15. The gripping control method of claim 11, wherein the robot hand is horizontally articulated or vertically articulated.

16. The gripping control method of claim 11, wherein evaluating whether the target object is slipping includes determining a decrease occurs in the value of the moment during the raising of the gripper.

17. The gripping control method of claim 11, wherein evaluating whether the target object is slipping includes determining a ratio of an increase in the value of the moment relative to the raising of the robot hand exceeds a threshold value.

18. The gripping control method of claim 11, wherein the robot hand includes an elastic body covering a sensing surface of the tactile sensor.

19. A robot hand comprising:
a plurality of fingers;
a gripper configured to support rear ends of the plurality of fingers and drive the plurality of fingers in a manner to grip or release a target object;
a tactile sensor provided on a gripping surface of each of the plurality of fingers, each tactile sensor configured to measure a shear force distribution on a sensing surface of the respective finger,
wherein the robot hand is configured to
detect the shear force distribution in a swirling pattern by the tactile sensor while the robot hand raises the gripper with the target object;
calculate a value of a moment applied to the robot hand from the shear force distribution;
evaluate whether the target object is slipping from a change in the value of the moment calculated during the raising of the gripper;
determine whether the target object is slipping based on the evaluation;
if the target object is slipping, estimate a centroid position of the target object within the gripper from a direction and a magnitude of the moment; and
move a gripping position of the robot hand to the centroid position of the target object.

20. The robot hand of claim 19, further comprising an elastic body covering the sensing surface of each of the tactile sensors.
